(19) United States
(12) Patent Application Publication
(10) Pub. No.: US 2002/0178016 A1
(43) Pub. Date: Nov. 28, 2002

(54) Method and apparatus for distributing parcels

(76) Inventor: Kerry McLellan, Rothesay (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 09/864,632

(22) Filed: May 23, 2001

(51) Int. Cl. G06F 17/60; G08B 13/14

(52) U.S. Cl. 705/1; 340/568.1

(57) ABSTRACT

The invention provides systems and methods for delivering parcels to convenient locations equipped with storage lockers. A delivery agent brings a parcel to the predetermined depot and selects an available storage locker for storing the parcel. Thereafter, the delivery agent contacts the system via a landline or wireless telephone, voice mail, e-mail, pager, or via any other method and reports the delivery. The system then informs the consumer via a notification agent such as a voice mail or e-mail system that the delivery was made and how to retrieve the parcel. The consumer may then retrieve the parcel at the consumer's convenience.

### FIELD OF THE INVENTION

The present invention relates generally to package delivery, and more specifically to methods and apparatus for delivering packages to a secure facility.

### BACKGROUND

Package delivery is a growing business in the United States and worldwide. Many companies, such as UPS®, Federal Express®, Airborne Express®, the United States Postal Service, etc., all compete for this business. However, with the increasing popularity of catalogue shopping and the Internet and in particular e-commerce, there has been an explosion in the number of packages being shipped. So much so, that it has been said that the shipping companies will not be able to keep up with the increase in demand.

Each year the volume of online purchases has grown significantly, resulting in increased shipment of parcels by online merchants. Due to the increased demand upon private couriers, the costs for shipping will continue to increase and the efficiency and timeliness of shipping will decrease if nothing is done to make package delivery more efficient and cost effective.

Additionally, shipping companies currently use expensive, proprietary systems for tracking packages. Thus, it is costly to hire additional personnel to deliver these packages since, in addition to training expense, and increased wages, each courier must be provided with a tracking device. Accordingly, it would be advantageous to provide a system for package delivery that uses inexpensive technology for tracking the packages and that enables fewer people to deliver more packages more efficiently.

There may also be security issues related to the delivered package. While it may not be objectionable to leave some parcels on a doorstep or on a driveway, other parcels may contain items that are confidential and/or expensive, such that the recipient does not wish the parcel to remain exposed to possible theft, damage or destruction. Also, the current delivery systems do not have the capability to broaden the types of parcels that are delivered, such as refrigerated items, or items that require a controlled environment. Thus, it would also be advantageous to provide a package delivery system that enabled a package to be delivered in a secure and/or environmentally controlled manner.

Another problem encountered under the current delivery systems is that a courier may perform multiple visits to a single address on the same day or over a period of several days for a single recipient or for a limited number of recipients. These multiple visits could be for the delivery of multiple packages and/or multiple attempts to deliver a single package. Thus, a centralized depository where a courier could leave packages for multiple recipients without the need to make multiple and additional delivery attempts for the same package would be advantageous.

It would thus be beneficial to have a method of delivery whereby items purchased could be delivered to centralized locations, that provide efficient access to secure storage, which accommodate parcels of various sizes and characteristics, for multiple recipients. It would also be beneficial if such a system were versatile enough to enable the delivery of parcels with cash on delivery (COD), or other charges, as these types of packages cannot be delivered when packages are delivered to a home and no person is present.

Having a central entity managing the flow of information between all participants, including the customer, the merchant, the delivery agent contracted by the merchant, the centralized storage location, and the storage agents would ensure consistency of transactions and sharing of information amongst all participants and thus be beneficial as well.

### SUMMARY OF THE INVENTION

The present invention provides methods and apparatus for delivering a parcel.

An aspect of the invention provides an apparatus for storing a parcel. The appratus includes a storage locker and a lock connected to the storage locker. The lock is configured to secure the storage locker in a closed state. The aparatus also includes a key for accessing the storage locker. The key is configured to change after the storage locker is accessed with the key.

Another aspect of the invention provides a method of delivering a parcel for receipt by a consumer. The method includes placing the parcel in a storage locker and locking the storage locker. The storage locker is accessible with a key. The method also includes changing the key subsequent to the key being used.

Another aspect of the invention provides a method for delivering a parcel from a sender to a consumer. The method includes the sender providing the parcel and a depot selection to a delivery agent. The delivery agent delivers the parcel to the depot. Subsequent to arriving at the depot, the delivery agent selects a storage locker in which to place the parcel and places the parcel into the storage locker. Subsequent to placing the parcel into the storage locker, the delivery agent provides a parcel identification and a storage locker identification to a central system. The central system causes the consumer to be contacted and provided with the depot selection, the storage locker identification, and a key for accessing the storage locker. The consumer arrives at the depot and uses the key to retrieve the parcel from the storage locker.

In still another aspect of the invention, apparatus is provided that includes a storage locker and an electronic combination lock connected to the storage locker. The lock is configured to secure the storage locker in a closed state. The lock is also configured to unlock when a predetermined key is entered. The key that unlocks the combination lock is configured to change upon being used to unlock the lock. The key is also synchronized with a key accessible at a location that is remote from the lock.

In yet another aspect of the invention, a sytem system for delivering a parcel to a consumer is provided, which includes a module for delivering the parcel to a depot. It also includes a module for storing the parcel at the depot. The sysem includes a module for identifying the storage module and a module for determining a key for accessing the storage module. The module for determining is associated with the module for identifying. Further, the system includes a module for communicating the module for identifying and the key to the consumer.

### BRIEF DESCRIPTION OF THE DRAWINGS

The invention will be more clearly understood by reference to the following detailed description of an exemplary embodiment in conjunction with the accompanying drawings, in which:

FIG. 1 depicts a flow chart of an embodiment of the invention;

FIG. 2 depicts an embodiment of a storage box arrangement for use with the embodiment depicted in FIG. 1

FIG. 3 depicts an embodiment of a single storage box from FIG. 2

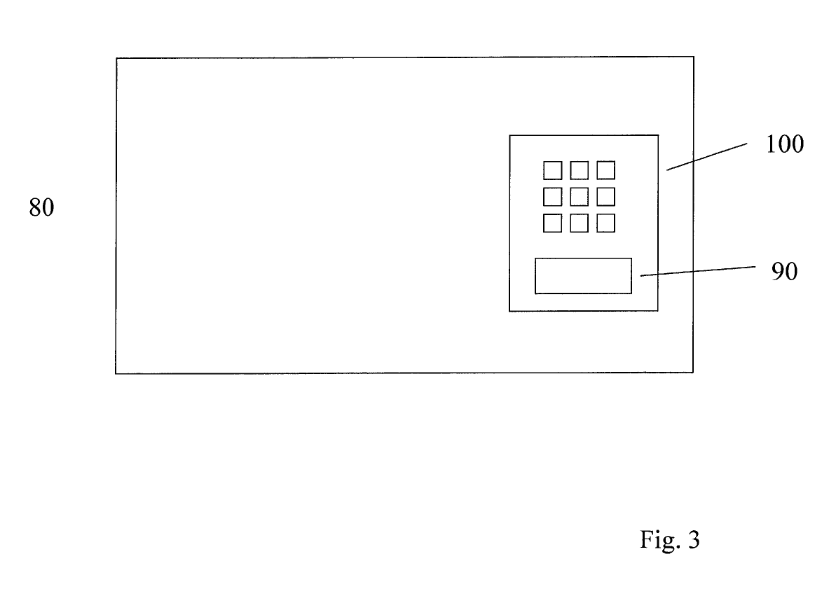

### DESCRIPTION OF THE INVENTION

The invention provides systems and methods for delivering parcels to centralized locations, and apparatus for storing these parcels at the centralized locations.

Before describing the invention further, the following definitions shall be used throughout this application.

Agent—person or other entity.

Consumer—intended receiver of a parcel.

Parcel—a letter or package for delivery to the consumer.

Delivery agent—person or other entity contracted to deliver a parcel.

Delivery management device—A device such as a pager, telephone (cellular, landline, etc), personal digital assistant (PDA), or any other device that is capable of two-way communication.

Storage locker—individual housing, group of housings for storing parcels, or a customer service counter with a storage area behind the counter. A storage locker is usually configured with an electronic combination lock, and may provide thermal controls or other environmental controls. The size and shape of the storage lockers may vary. Storage lockers are classified as connected or unconnected, according to whether they are connected via a network to the system or not.

Depot—facility for storing parcels. May be a separate store, a department in a larger store, the lobby of a building, or a single or multi-family home. Typically, a depot will house various storage lockers, but a depot may also house a single home storage locker, or a customer service counter with a storage area behind the counter.

Key—any device or code that can be used to open a storage locker or otherwise gain access to a delivered parcel, such as a combination entered on an alpha-numeric keypad that is integrated with an electronic locking mechanism to gain entry to a locked storage agent, a smart card, an integrated circuit card or some other type of card key that is swiped with a card reader that is integrated with an electronic locking mechanism to gain entry to a locked storage locker, a physical key that opens a mechanical lock on the storage locker, a biometrical key for accessing a biometrically keyed lock, or a password provided to a depot attendant, etc.

Delivery access key—a key that is used when a storage locker is being opened for delivery of a parcel.

Item access key—a key that is used when a customer is retrieving a parcel.

Expired item access key—a key that is used when a customer attempts to retrieve a parcel after an allotted time for retrieval has passed.

The system may distinguish between these three types of keys, but there need not be an apparent difference to the user.

Kiosk—a self-service station, similar to an Automated Teller Machine (ATM), providing a computer-based service in the delivery or retrieval of a parcel.

Notification agent—a communication entity, such as a telephony, voice-mail, or email service.

System—the heart of the operation including the active information store.

The preceding terms shall be used throughout the following description.

The invention provides systems and methods for delivering parcels to depots and apparatus for storing these parcels at the depots.

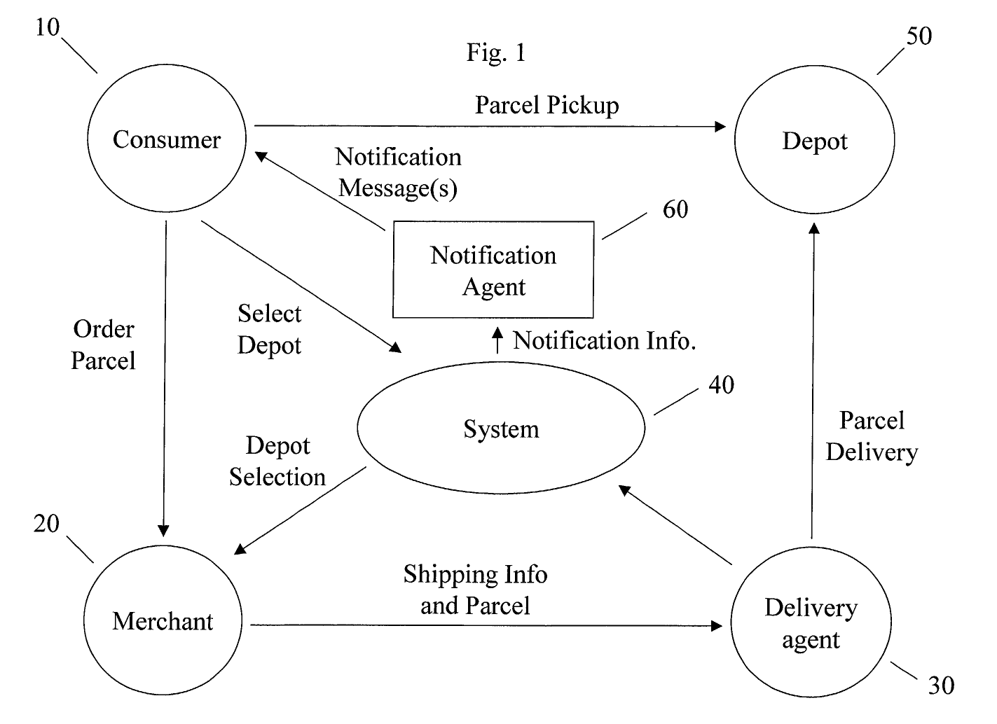

In an embodiment of the invention illustrated in FIG. 1, a consumer 10 makes a purchase via the Internet (not shown). One of the delivery options provided to the consumer 10 is having the purchase delivered to a depot 50. When this method of delivery is selected, the consumer 10 accesses an ordering utility and specifies a depot 50 to which the parcel should be delivered. The consumer 10 may be provided with the option of registering with the system 40 to establish preferences for depots 50, delivery methods, and/or notification methods. Such registration could be used to streamline the process for future deliveries.

The address information regarding the depot 50 selected is forwarded to the merchant 20, who then contracts with a delivery agent 30 for delivery of the parcel. The delivery agent 30 upon arriving at the specified depot 50 with the parcel, contacts the system 40 using a delivery management device (e.g. a cell phone, pager, PDA, etc). Identification of the delivery agent 30 and the parcel are verified by the system 40, after which, the agent 30 is permitted to retrieve a delivery access key for an available storage locker 80 within the depot 50. The delivery agent 30 selects an available storage locker 80, opens it using a delivery access key, and locks the parcel inside. Upon being locked, the storage locker 80 or the system 40 calculates an item access key (possibly using information input by the delivery agent 30). This calculation may be done using an algorithm shared by the storage locker 80 and the system 40. While almost any algorithm would work with the system, it is preferable to have a relatively complex algorithm. The storage locker 80 keeps track of its status (e.g. available, occupied, open, closed, stale, etc.) and at this point changes its state from available to occupied. The delivery agent 30 then gives a parcel identification number and a storage locker identification number to the system 40 which updates its information (e.g. marking the storage locker 80 as occupied, calculating the item access key using the same method as the storage locker 80, etc). If the storage locker 80 is connected to the system 40, the locker state and item access key information may be updated simultaneously by a shared process. If the storage locker 80 is not connected to the system, the item access key is updated separately by the locker 80 and by the system 40, but it remains synchronized.

The system 40 then informs the consumer 10, via one or more customized messages sent through a notification agent 60 affiliated with the system, that a delivery was made. If the consumer 10 is registered with the system 40, the notification agent 60 notifies the consumer 10 via a consumer specified voice-mail, email, pager, or other communication address. Otherwise, a default voice-mail is sent to the consumer's phone number. Those skilled in the art will recognize that the default message need not be limited to a voice mail and need not be limited to a single message or message type. A notification message may include but is not limited to: identification of the parcel, depot identification (which could include an address), the storage locker identification for the storage locker used to house the item, and the item access key that can be used by the consumer 10 to access the parcel. When permitted by the notification agent 60, the system tracks notification messages, so that at any point in time the system has knowledge of the status of each message including whether the message was sent and whether it was received. This allows the system 40 to follow up with additional notification messages, ensuring that the consumer 10 receives notification of deliveries in a timely fashion.

The consumer 10, upon arriving at the depot 50, makes payment of any COD or storage charges owing on the parcel, according to the rules of the depot 50. This could be enforced by not providing the consumer with the key until payment is received, by requiring a consumer 10 to check in with the depot attendant in order to gain access to the depot 50 or the portion of the depot housing the storage lockers 80, etc.

To retrieve the parcel, the consumer 10 enters the item access key into a lock on the storage locker 80. When the door to the storage locker 80 is opened, the storage locker 80 changes its state to open. When the storage locker 80 is again closed, the storage locker 80 locks, calculates a new delivery access key, and changes its state to available. If a consumer 10 accidentally closes the door prior to retrieving the parcel, there could be protocols in place for gaining access to the storage locker 80. These protocols will not be discussed at this time, but some possible protocols are discussed below.

If a parcel is delivered and the consumer 10 fails to retrieve it within a specified time limit, the storage locker 80 automatically changes its state to expired, and recalculates the item access key. This prevents the consumer 10 from retrieving the item without paying applicable storage charges. If the storage locker 80 remains in an expired state for a specified period of time, the storage locker 80 changes its state to stale in which case the package may need to be returned to sender. The system also is updated by making the same state and key changes for that storage locker 80, and modifying its records pertaining to that delivery so that the expired or stale status is reflected.

In the above described embodiment, illustrated in FIG. 1, the consumer 10 is also the intended recipient of the parcel. However, it will be apparent to those skilled in the art that the intended recipient could be a third party and still fall within the scope of the invention. Thus, the term consumer will encompass a third party recipient.

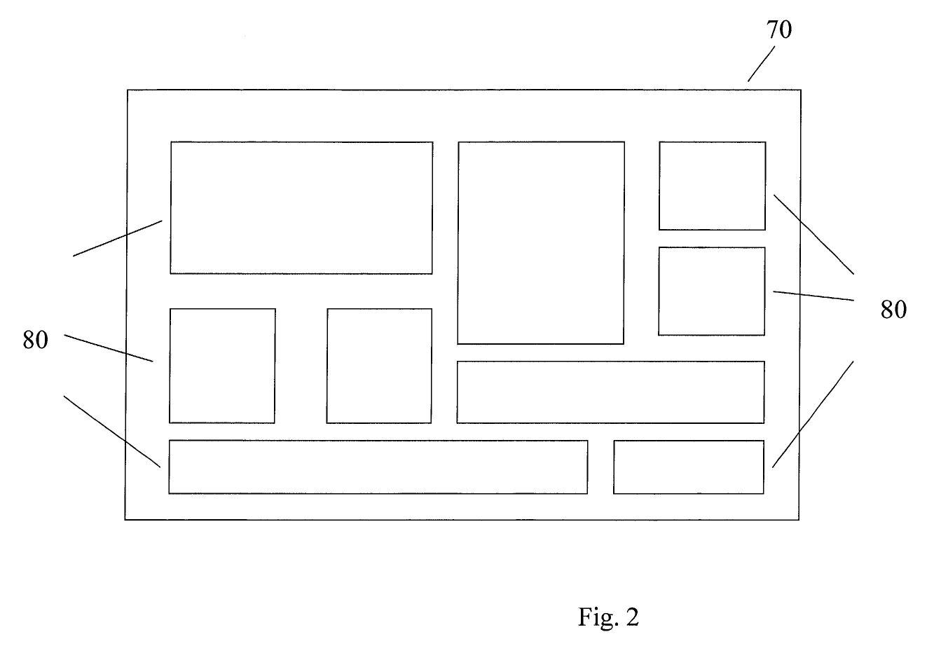

Storage lockers 80 may vary in size and shape, as illustrated in FIG. 2. Some may be outfitted with thermal controls, insulation, or other environmental controls. Some may have additional security features and be designated as high security storage lockers.

The storage locker 80 arrangement within a depot 50 may include: a variety of individual storage lockers 80 of different dimensions, multiple storage lockers 80 of the same dimensions; combined storage lockers 80 with multiple doors for a single enclosure, etc. However, preferably, each individual storage locker 80 has a separate entrance and identification.

In another embodiment, the delivery agent 30 delivers the parcel to the depot 50, and the depot 50 determines in which storage locker 80 the parcel will be stored. The depot 80 communicates this information to the system.

The depot 50 may contain no storage lockers 80 other than the service counter, in which case the delivery agent 30 leaves the parcel at the service counter. The depot 50 may also be a single storage locker 80 located at a residence for use by a single family house, a multiple family house, a building, or a small community.

In another embodiment, the storage lockers 80 are secured with standard mechanical key locks. A delivery agent 30 deposits a parcel in an available storage locker 80, removes the key and leaves it at the service counter. The customer 10 is then notified with an item access key that is a password, to present to the service counter for retrieval of the parcel. The depot 50 has access to the system so that an employee may validate the password when it is presented by the consumer 10. If the password is validated, the depot 50 will provide the key to the consumer to unlock the appropriate storage locker 80 and retrieve the parcel.

In another embodiment, the delivery agent 30 has access to a key that opens a master lock that opens all of the storage lockers 80 or a select group of the storage lockers 80 simultaneously (e.g. like the post office does for banks of postal boxes), in which case the delivery agent 30 uses this key to place parcels into different storage lockers 80. This key may also be provided to the depot 50 in the event that a consumer 10 accidentally locks the storage locker 80 before removing the parcel. This could be especially useful if banks of storage lockers 80 are assigned to different delivery agents 30.

In another embodiment, the delivery agent 30 is provided with a master key that opens each storage locker 80 individually, in which case the delivery agent 30 uses that master key to place parcels into different storage lockers 80. Again, this key may also be provided to the depot 50 in the event that a consumer 10 accidentally locks the storage locker 80 before removing the parcel.

In yet another embodiment, the storage locker 80 remains unlocked until either it is opened once and closed once (or some other predetermined number of times) or until the delivery agent 30 sets the lock to lock (either by pressing a button or entering a code, removing a key from a lock, etc.). The system runs the same algorithm as the storage locker 80, and can therefore determine the new combination each time the lock is locked.

In the event that there are no available storage lockers 80 in the depot 50 that meets the requirements of a parcel, the delivery agent 30 may divert the parcel to a service counter or to another depot 50, or may hold the parcel for redelivery according to a predetermined procedure.

If the consumer 10 is registered with the system, the established consumer preferences are taken into account at this stage to help determine an alternate depot 50 to which the parcel can be diverted.

If COD charges apply to the parcel being delivered, the delivery agent 30 will follow the rules of the depot 50, and deliver the parcel either to a service counter or to another storage locker 80 accordingly.

In a preferred embodiment of the present invention all communications occur over one network, such as the telephone network, a global computer network such as the Internet, a local network or a wireless network, although multiple networks may be employed for different aspects of the invention. The storage locker 80 or the lock 100 may be capable of registering with the system 40. It may do so using Bluetooth, HomeRF, some other wireless standard, a hardwire standard, or any other communication standard. When registering, the locker status and access key are provided to the system 40. Further status updates are also provided to the system 40.

The notification agent 60 preferably provides the consumer with retrieval instructions automatically after the parcel is delivered. However the consumer 10 could be allowed to arrange for the notification agent 60 to only provide the consumer 10 with instructions for retrieval of the parcel when the consumer 10 contacts the notification agent 60. It will be apparent to those skilled in the art that the latter embodiment can be accomplished by an automated telephone system, whereby retrieval instructions are provided to the consumer 10 only upon the automated telephone system recognizing the consumer 10 by use of caller identification information or some other identification method.

In an alternate embodiment, an individual may wish to have a parcel delivered from his or her possession and have the parcel retrieved at a depot 50 by another individual or entity (consumer). The sender contacts the delivery agent 30 to arrange for the delivery. In doing so, either the sender will select the depot 50, if the consumer is registered with the system, the consumer's preferences may be employed, or the delivery agent may select the depot 50. The remainder of the process is the same as that described in relation to a merchant sending a parcel to a consumer, and will thus not be repeated.

It will be understood that changes may be made in the above construction and in the foregoing sequences of operation without departing from the scope of the invention. It is accordingly intended that all matter contained in the above description or shown in the accompanying drawings be interpreted as illustrative rather than in a limiting sense.

The following claims are intended to cover all of the generic and specific features of the invention described herein, and all statements of the scope of the invention which, as a matter of language, might be said to fall there between.

Having described the invention, what is claimed is:

1. Apparatus for storing a parcel comprising:
a storage locker;
a lock coupled to said storage locker and configured to secure said storage locker in a closed state;
a key for accessing said storage locker;
wherein said key is configured to change after said storage locker is accessed with said key.

2. The apparatus according to claim 1 wherein said key is synchronized with a key accessible at a location that is remote from said lock.

3. The apparatus according to claim 2 further comprising a network selectively coupled between said remote location and said lock configured to allow communication between said remote location and said lock.

4. The apparatus according to claim 1 wherein:
said lock is a mechanical lock and said key is a password for accessing a physical key that opens said lock.

5. The apparatus according to claim 1 wherein:
said lock is an electronic lock.

6. The apparatus according to claim 5 wherein:
said key is a card key.

7. The apparatus according to claim 6 wherein:
said card key is a smart card.

8. The apparatus according to claim 6 wherein:
said card key is an integrated circuit card.

9. The apparatus according to claim 1 wherein:
said lock is a biometric lock and said key is a biometric key.

10. The apparatus according to claim 1 wherein:
said storage locker includes environmental controls.

11. The apparatus according to claim 1 further comprising:
a plurality of said storage lockers.

12. The apparatus according to claim 11 wherein:
a dimension of each of at least two of said storage lockers is different.

13. The apparatus according to claim 11 wherein:
said key is capable of accessing a plurality of said storage lockers.

14. The apparatus according to claim 11 wherein:
at least two of said plurality of storage lockers are secured by a common lock.

15. The apparatus according to claim 11 further comprising:
a master key configured to open at least two of said plurality of storage lockers.

16. A method of delivering a parcel for receipt by a consumer, said method comprising:
placing said parcel in a storage locker,
locking said storage locker;
wherein said storage locker is accessible with a key; and,
changing said key subsequent to said key being used.

17. The method according to claim 16 further comprising:
synchronizing said key with another key that is accessible at a location that is remote from said lock.

18. The method according to claim 16 further comprising:
using said key to retrieve another key;
unlocking said lock with said another key.

19. The method according to claim 16 further comprising:
contacting a central system using a delivery management device; and,
retrieving said key from said central system.

20. The method according to claim 16 further comprising:
contacting a central system with a delivery management device and logging said delivery.

21. The method according to claim 20 wherein:
said logging includes providing a parcel identification and a storage locker identification to said central system.

22. The method according to claim 21 further comprising:
said central system determining said key using said storage locker identification; and
said central system forwarding said key and said storage locker identification for receipt by said consumer.

23. The method according to claim 21 further comprising:
said central system updating a status of said storage locker.

24. The method according to claim 21 further comprising:
said central system providing said consumer with at least said storage locker identification.

25. The method according to claim 24 further comprising:
said central system providing said consumer with said key.

26. The method according to claim 24 further comprising:
said system verifying that said identification was sent to said consumer.

27. The method according to claim 24 further comprising:
said system verifying that said identification was received by said consumer.

28. The method according to claim 16 further comprising:
said storage locker registering with a central system;
wherein said registration includes providing a status of said storage locker.

29. The method according to claim 28 wherein said registration further comprises:
providing an initial access key for said storage locker.

30. The method according to claim 28 further comprising:
said storage locker updating said status subsequent to said storage locker being opened.

31. The method according to claim 25 further comprising:
said storage locker updating said status subsequent to said storage locker being locked for a predetermined period of time.

32. The method according to claim 31 further comprising:
said storage locker changing said key subsequent to said storage locker being locked for said predetermined period of time.

33. The method according to claim 16 further comprising:
a central system having another key synchronized with said key; and, said central system changing said another key to keep said another key synchronized with said key.

34. A method for delivering a parcel from a sender to a consumer, said method comprising:
said sender providing said parcel and a depot selection to a delivery agent;
said delivery agent delivering said parcel to said depot;
subsequent to arriving at said depot, said delivery agent selecting a storage locker in which to place said parcel and placing said parcel into said storage locker;
subsequent to placing said parcel into said storage locker, said delivery agent providing a parcel identification and a storage locker identification to a central system;
said central system causing said consumer to be contacted and provided with said depot selection, said storage locker identification, and a key for accessing said storage locker;
said consumer arriving at said depot and using said key to retrieve said parcel from said storage locker.

35. Apparatus for storing a parcel comprising:
a storage locker;
an electronic combination lock coupled to said storage locker and configured to secure said storage locker in a closed state, wherein said lock is configured to unlock when a predetermined key is entered;
wherein said key that unlocks said combination lock is configured to change upon being used to unlock said lock; and
wherein said key is synchronized with a key accessible at a location that is remote from said lock.

36. The apparatus according to claim 29 wherein said remote location is in communication with said lock via a network.

37. A system for delivering a parcel to a consumer comprising:
means for delivering said parcel to a depot,
means for storing said parcel at said depot;
means for identifying said means for storing;
means for determining a key for accessing said means for storing;
wherein said means for determining is associated with said means for identifying; and
means for communicating said means for identifying and said key to said consumer.
